(19) United States
(12) Patent Application Publication
(10) Pub. No.: US 2010/0240421 A1
(43) Pub. Date: Sep. 23, 2010

(54) Cellular phone cover/case that blocks radiation from reaching the user through the implementation of faraday cage and/or conductive material properties

(76) Inventors: Michael Sekora, New York, NY (US); Jeffrey Mroz, Greensbarg, PA (US)

Correspondence Address: Jeffrey Mroz, 3 Brookmere Drive, Greensburg, PA, 15601, US

(21) Appl. No.: 12/659,677

(22) Filed: Mar. 17, 2010

Related U.S. Application Data
(60) Provisional application No. 61/202,601, filed on Mar. 17, 2009.
(60) Provisional application No. 61/272,738, filed on Oct. 28, 2009.

(51) Int. Cl. H04M 1/00

(52) U.S. Cl. 455/575.1

(57) ABSTRACT

The inventors have invented a cellular phone case designed to block cellular phone radiation from reaching the user's body. The inventors have identified the proper Faraday cage materials necessary to permit one to use the case on the phone in an effective radiation-blocking manner, during nearly all stages of cell phone use. This feature is an improvement over the prior art. Further, the inventors have disclosed a cell phone made out of a heterogeneous and transparent Faraday-cage material formed by doping Faraday metal nanoparticles directly into said cover or shell, another improvement over the prior art.

### BACKGROUND

1. Field

This application relates to cellular phone cases that block radiation from reaching the user through the use of, among other things, transparent Faraday-cage material properties.

2. Introduction

All cell phones emit electromagnetic radiation. The impact of cell phone radiation on the human body has been a debated research topic in recent years. Although research pertaining to the potential dangers of cell phone radiation is not conclusive, evidence is mounting to strongly support the conclusion that cell phone radiation can cause cancer, infertility, Alzheimer's and/or fatigue. Research also suggests that cell phone radiation is especially harmful to children.

Many scientists believe that the electromagnetic radiation from cell phones can induce leakage in the barrier between the circulatory system and the brain (i.e., the “blood-brain barrier). Disrupting the blood-brain barrier is dangerous and can cause neurons in the brain to not function properly. Even more, some scientists assert that cell phone radiation can alter the actual structure of DNA.

Some believe that the potentially harmful connection between cell phones and physical maladies such as brain cancer is similar to that of smoking and lung cancer. It is possible that the physical harm is not immediately obvious, but that the ill-effects emerge after years of repetitious use. It may take many years before scientists are able to conclusively link cell phone radiation to being a cancer-causing agent.

Given the extent to which cell phones have infiltrated the consumer market and are used in today's world, a conclusion linking cell phones to certain malicious health consequences such as cancer would be devastating to society. The extreme severity of the potential harm caused by cell phones (i.e., death) warrants taking precautionary measures to reduce cell phone radiation. The present invention is designed to minimize the potential health risks associated with using cell phones by lowering one's exposure to radiation while using the device.

### Faraday Science

A Faraday cage or Faraday shield is an enclosure formed by a conducting material or by a mesh of such material that blocks external static electric fields. A Faraday cage's operation depends on the fact that an external static electrical field will cause the electrical charges within the cage's conducting material to redistribute so as to cancel the field's effects in the cage's interior.

A microwave oven is useful in illustrating this principle. A microwave oven uses microwaves to heat the food without permitting the waves to escape into the external environment. The microwave's five metal sides and a glass door, which often contains a metallic mesh, create the Faraday cage that encapsulates the radiation. This spacing of the metal in the mesh design is such that higher frequency visible light waves (400,000-800,000 GHz) are allowed to pass through the openings, lower frequency microwaves (0.3-300 GHz) are not. As a result, one can see a microwave oven heating the food without being exposed to significant amounts of radiation.

The invention described herein works on a similar principle. The Faraday material in the case allows one to see the screen through the transmission of visible light waves but not be exposed to the microwaves emitted by the cellular phone. These microwaves are directed away from the user.

### 1. Dielectric Material

A dielectric is an electrical insulator that may be polarized by the action of an applied electric field. When a dielectric is placed in the electric field, electric charges do not flow through the material, as in a conductor, but only slightly shift from their average equilibrium positions, causing dielectric polarization: positive charges are displaced along the field and negative charges shift in the opposite direction. This creates an internal electric field which partly compensates the external field inside the dielectric.

Permittivity is a measure of how an electric field affects, and is affected by, a dielectric medium. This property is determined by the ability of a material to polarize in response to a field and thereby reduce the total electric field inside the material. Thus, permittivity relates to a material's ability to transmit (i.e., permit) an electric field.

The permittivity ε and permeability μ of a medium together determine the phase velocity c of electromagnetic radiation through that medium:

$$c = \sqrt{\frac{1}{ɛμ}}$$

where
such that εᵣ is the relative permittivity of the material, and ε₀ is the vacuum permittivity. For example, εᵣ is 2.25 for polyethylene. Therefore, as electromagnetic radiation passes through this material it is slowed to ⅔ times the speed of light in a vacuum because

$$\begin{matrix}n ≡ \sqrt{\frac{1}{{ɛ}_{r}}} \\ = \sqrt{\frac{1}{2.25}} \\ = \frac{1}{1.5} \\ = \frac{2}{3}\end{matrix}$$

### 2. Length Scale of Technology

It is important to consider over which length scale this blocking and redirecting technology is valid. Given that n is ⅔ for polyethylene (material over which the Faraday particles are deposited), c is 3×10⁸ m/s in vacuum, and v is 2 GHz for the microwave radiation used in most cellular phones, then one can define the following length scale (wave length) for which Faraday blocking technology is classically valid

$$L = \frac{nc}{v} = 0.1 m = 10 cm \approx 4 in$$

which is roughly the length scale of the face of the cellular phone. Therefore, the Faraday principles are valid when applied to cell phone technology.

### 3. Attenuation Versus Frequency

Faraday materials come in many forms and include coated plastics, metallic meshes, and even fabrics. Such materials are available through many companies such as Less EMF. These companies provide performance results for a number of different materials sold in the area of electromagnetic field shielding. Less EMF provides attenuation versus frequency images for their products on their website (http://www.lessemf.com/). These images represent laboratory tests showing that Faraday cage materials can block cellular phone radiation.

3. Prior Art

The prior art teaches, at a very general level, cellular phone cases incorporating Faraday-cage materials intended to block radiation from the phone. The present invention, however, contains many additional distinctive features and advancements not taught by the prior art. Some of these distinctive features are outlined below.

First, U.S. Pat. Nos. 5,726,383, 6,075,977, 6,515,223, as well as US 2002/0009976 A1, US 2004/0198264 A1 all disclose the use of Faraday cage materials to block cell phone radiation. Critically, these examples do not incorporate transparent Faraday cage materials. Therefore, one cannot adequately view the cellular phone display screens, or other interfaces, if the Faraday cage material covers that portion the phone. Perhaps to combat this lack of transparency, some prior art examples are designed such that the Faraday materials do not cover the display portion of the phones. Such a design renders the case ineffective, since the radiation emitted from these display portions of the phone is not blocked.

The present invention incorporates transparent Faraday cage materials. This feature permits the user to enjoy radiation protection while the case continuously remains on the phone during normal use. In other words, the present invention has the capability to protect the user, by remaining on the phone, at nearly all instances of ordinary operation, such as when the phone is in the user's pocket, when phone is placed next to the head during a conversation, and when the user is viewing the display screen.

Further, many of the alleged anti-radiation cell phone cases and shields taught by the prior art must be tampered with or adjusted in a significantly disruptive or ineffective manner during the different stages of their use in order to be operated properly. Many of these cases are incompatible with modern cell phone technology such as touch screens, scroll balls, and scroll bars. As a result, many of the devices taught by the prior art are so inconvenient, burdensome, and impractical that they are unlikely to be used by a customer. The present invention, on the other hand, is simple to use and accommodates the newest cell phone technologies.

Additionally, some anti-radiation phone cases and shields disclosed in the prior art are intended to only operate and be effective during specific phases of the cell phone-user process. For example, some cases or shields are only operational when the phone is stored in one's pocket or on one's belt. When the user wants to dial a number, hold the phone next to his head during a conversation, or use the phone in some other ordinary manner, he must remove the phone from the case, exposing him to radiation. On the other hand, some cases or shields are intended for use on the phone primarily when the phone is next to the head during conversation and are too large to fit into one's pocket. As a result, such devices do not protect the user while the phone is stored in her pocket.¹ The present invention is an improvement over the prior art because it shall ameliorate many of the aforementioned inconveniences and disruptions associated with the devices taught by that prior art. ¹ The above comparisons do not provide an exhaustive list of the differences between the present invention and the prior art. More differences exist. The above illustrations are merely intended to highlight some of the major areas where the present invention is an improvement over the prior art.

The prior art also discloses transparent Faraday cage materials to block cell phone radiation. Specifically LessEMF sells a Faraday cage-based anti-radiation device designed for cell phones called SkinBlok. This device, however, is a cellular phone sticker, not a cellular phone case.

Additionally, LessEMF advertises that its device should not be used with a touch screen phone. http://www.lessemf.com/cellphon.html. This product is also not compatible a phone containing a scroll ball on the front of the phone, such as a Blackberry. Unlike the LessEMF device, the present invention is designed to comply with modern phone technology such as touch screen phones and phones with scroll balls and scroll bars.

Further, LessEMF discloses that its device provides roughly 40 dB of attenuation. http://www.lessemf.com/cellphon.html. The inventors have identified a transparent Faraday cage material utilized by the present invention capable of much higher attenuation levels, meaning the present invention can block more radiation than the LessEMF product. Id.

Indeed, many of the transparent Faraday cage materials currently on the market are similar to the LessEMF SkinBlok product in that they are unable to provide attenuation levels comparable to solid Faraday cage metals. Therefore, many of these materials would be less than ideal if used to block cell phone radiation.

One embodiment of the present invention solves this problem by incorporating a transparent Faraday cage material made with metal nanoparticles (such as silver nanoparticles) into the cell phone case. Use of the metal nanoparticles creates a Faraday cage material that is transparent but capable of substantial attenuation. The inventors have identified a silver nanoparticle product manufactured by Sima Nanotech that is incorporated in the present invention. That the inventors have identified a groundbreaking, transparent silver nanoparticle Faraday cage product, and applied that product to the cellular phone field is a significant improvement over the prior art.

In another embodiment of the present invention, a metal, such as copper, can be added to the metal nanoparticles to create even more attenuation, while still maintaining transparency.

Importantly, the applicant was unable to find any prior art teaching the use of transparent Faraday cage materials with a cellular phone case. And other than the LessEMF SkinBlok sticker product, the applicant was unable to identify in the prior art a cell phone anti-radiation product utilizing transparent Faraday cage materials. As mentioned above, the Skin Blok product is not compatible with touch screen phones and scroll ball phones where the scroll ball is located on the face of the phone. Further, this product has low attenuation. The present invention is compatible with phones having touch screen and scroll ball features, and is capable of higher attenuation, which is an improvement over the prior art.

Even if such a phone case utilizing transparent Farady cage materials existed, it is unlikely that its transparent material is capable of blocking as much radiation as the transparent material utilized in the present invention while still maintaining sufficient transparency.

Furthermore, unlike many examples found in the prior art, the present invention was tested and proven to work in a commercial laboratory setting. These tests showed the present invention, in addition to blocking radiation waves from reaching the user's head, actually redirected waves away from the user.

Finally, another important feature taught by an embodiment of the present invention, which is not taught by the prior art, involves doping the Faraday nanoparticles directly into the body of the case. Specifically, the Faraday nanoparticles are doped with the material used to create the structure of the case (e.g., polyethylene plastic) during the injection molding process. As a result, a heterogenous and transparent material is formed possessing inherent Faraday properties. A cellular phone case possessing these qualities is a significant improvement over the prior art.

### SUMMARY OF THE INVENTION

The present invention is a phone case designed to significantly limit the amount of cell phone radiation contacting the body. The case uses materials with Faraday properties (“Faraday materials”)² to block a substantial portion of the radiation emitted from the front and sides of the phone. Different Faraday or conductive materials that may be utilized in the present invention include, but are not limited to, the following: Indium-tin-oxide (ITO) materials, ITO alternative materials such as carbon nanotube conductive materials, silver nanoparticle materials, other metal nanoparticles, and metal-based conductive materials, including silver based paints or inks ² A Faraday material is some conductive or slightly conductive material (e.g., mesh, fabric, coated plastic, etc.) that when an electric field is applied to it the electrical charges within the material redistribute themselves so as to cancel the field's effects on the other side of the material. The effectiveness with which a Faraday material shields an area depends on the thickness of the material and whether any holes exist in the material. Typically, greater thickness allows for better shielding. However, a Faraday material becomes porous to a certain type of radiation if holes exist in the material comparable in size to the wavelength of the said radiation. A simple example of how a Faraday material can be used for electromagnetic shielding is a coaxial cable. Here, a wire mesh surrounds an inner core conductor such that the shielding impedes the escape of any signal from the core conductor and prevents additional signals from being added to the core conductor.

The case contains either an opening or non-Faraday cage material in the back of the phone, which is the area where the signal is permitted to enter and exit the phone. Despite the signal being permitted to enter and exit the back side of the phone, the present invention still blocks a significant amount of radiation emitted from the back of the phone.

The transparent Faraday or conductive material implemented by the present invention permits light waves to pass through, but not microwaves. Thus, while a transparent Faraday or conductive material blocks microwaves, one can still see through the material. The transparent Faraday or conductive materials implemented in the present invention are aligned to lay over the display screen and keypad areas of the phone. Therefore, the user can see the cell phone's display screen and keypad even when the Faraday materials are covering those portions of the phone and shielding the user from radiation.³ ³ The cell phone signal exchanged between the phone and tower is a microwave. This signal is one source of radiation emitted from the cell phone. Another source of radiation is the battery. The present invention shall protect against both types of radiation.

In one embodiment of the present invention, the remaining surface area of the phone case (i.e. the non-display screen, non-keypad, and non-open portions) shall be covered primarily with a plastic, rubber, leather, or other comparable material which is lined with a Faraday or conductive material. Many different types of Faraday or conductive materials exist, such as cloth materials, plastic materials, paints, inks, etc. The Faraday or conductive lining material in the present invention can consist of nearly any of these different types of materials.

In another embodiment of the present invention, the entire cell phone case is made out of a heterogeneous and transparent Faraday-cage material formed by doping Faraday metal nanoparticles directly into said cover or shell. These metal nanoparticles can be silver nanoparticles. In this embodiment, portion of the back side of the cell phone case is not covered by heterogeneous and transparent Faraday-cage material, thereby permitting the electromagnetic waves to enter and exit the phone.

These and other objects, along with advantages and features of the invention disclosed herein, will be made more apparent from the description, drawings, and claims that follow.

### BRIEF DESCRIPTION OF THE DRAWINGS

The accompanying drawings, which are incorporated into and form a part of the instant specification, illustrate several aspects and embodiments of the present invention and, together with the description herein, and serve to explain the principles of the invention. The drawings are provided only for the purpose of illustrating select embodiments of the invention and are not to be construed as limiting the invention

FIG. 1 schematically illustrates an embodiment of the present invention as applied to a traditional “flip phone” design.

FIG. 2 schematically illustrates an embodiment of the present invention as applied to a non-flip phone design where the keypad and display screen are contained on the front face of the phone.

FIG. 3 schematically illustrates an embodiment of the present invention as applied to a touch-screen phone design.

FIG. 4 schematically illustrates an embodiment of the present invention as applied to a touch-screen phone design.

FIG. 5 schematically illustrates the back portion of the present invention. This illustration applies to the embodiments disclosed in FIGS. 1-4.

FIG. 6 schematically illustrates the flip phone design while the phone is in its folded-down state.

### DETAILED DESCRIPTION OF PREFERRED EMBODIMENTS AND DRAWINGS

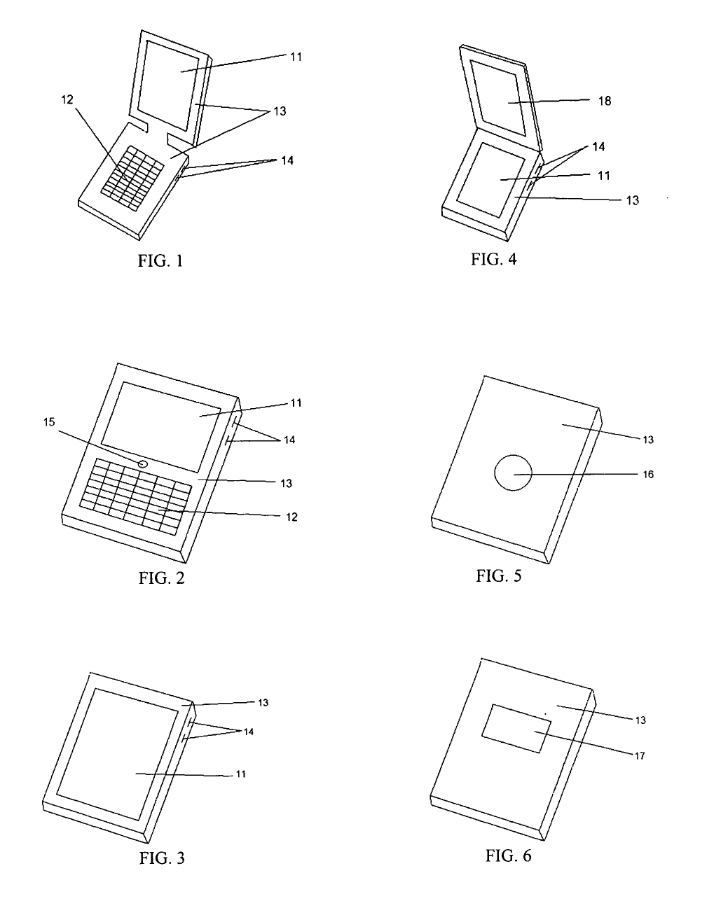

FIGS. 1-4 depict the present invention as applied to different cell phone designs. The present invention, however, is not limited to being used in these specific designs and may be applied to other designs not shown in the drawings.

FIG. 1 illustrates the present invention on a traditional “flip phone” design. In one embodiment, the shell covering the non-display portions of the phone 13 may consist of, but is not limited to, plastic, rubber, or leather. This shell 13 shall be lined with a Faraday or conductive material. This material lining the shell shall consist of a cloth-like, plastic-like, paint, ink, or nearly any other type of Faraday or conductive material. The display portions of the phone, which may consist of but are not limited thereto, the keypad area 12 and the display screen 11, shall be covered with a transparent Faraday or conductive material that enables the user to operate the phone while the cover remains on it. This transparent material may consist of, but is not limited to, an ITO material, carbon nanotube material, silver nanoparticle material, or a transparent conductive mesh material. Additionally, the present invention shall be designed to comport with any jacks, cameras, ports, scroll balls, or any other comparable device contained on the phone 14.

In another embodiment, the entire cell phone case 11, 12, and 13 is made out of a heterogeneous and transparent Faraday-cage material formed by doping Faraday metal nanoparticles directly into said cover or shell. These metal nanoparticles can be silver nanoparticles. In this embodiment, a portion of the back side of the cell phone case is not covered by heterogeneous and transparent Faraday-cage material, thereby permitting the electromagnetic waves to enter and exit the phone.

FIG. 2 illustrates an embodiment of the present invention as applied to a non-flip phone design where the keypad and display screen are contained on the front face of the phone. The shell covering the non-display portions of the phone 13 may consist of, but is not limited to, plastic, rubber, or leather. This shell 13 shall be lined with a Faraday or conductive material. This material lining the shell shall consist of a cloth-like, plastic-like, paint, ink, or nearly any other type of Faraday or conductive material. The display portions of the phone, which may consist of but are not limited thereto, the keypad area 12 and the display screen 11 shall be covered with a transparent Faraday or conductive material that enables the user to operate the phone while the cover remains on it. This transparent material may consist of, but is not limited to, an ITO material, carbon nanotube material, silver nanoparticle material, or a transparent conductive mesh material. Additionally the present invention shall be designed to comport with any jacks, cameras, ports, scroll balls, or any other comparable device contained on the phone 14, 15.

In another embodiment, the entire cell phone case 11, 12, and 13 is made out of a heterogeneous and transparent Faraday-cage material formed by doping Faraday metal nanoparticles directly into said cover or shell. These metal nanoparticles can be silver nanoparticles. In this embodiment, a portion of the back side of the cell phone case is not covered by heterogeneous and transparent Faraday-cage material, thereby permitting the electromagnetic waves to enter and exit the phone.

FIG. 3 illustrates an embodiment of the present invention as applied to a touch-screen phone design. The shell covering the non-display portions of the phone 13 may consist of, but is not limited to, plastic, rubber, or leather. The shell 13 shall be lined with the Faraday or conductive material. This material lining the shell shall consist of a cloth-like, plastic-like, paint, ink, or nearly any other type of Faraday or conductive material. The display portion of the phone, which consists of the display screen 11, shall be covered with a transparent Faraday material that enables the user to see the display screen 11 and operate the phone while the cover remains on it. This transparent material may consist of, but is not limited to, an ITO material, carbon nanotube material, silver nanoparticle material, or a transparent conductive mesh material. One intended embodiment of the present invention would involve removing or folding away the portion of the cell phone case covering the display screen 11 during use. This removable or foldable portion would remain connected to the cell phone case, however. Additionally, he present invention shall be designed to comport with any jacks, cameras, ports, scroll balls, or any other comparable device contained on the phone 14, 15.

In another embodiment, the entire cell phone case 11 and 13 is made out of a heterogeneous and transparent Faraday-cage material formed by doping Faraday metal nanoparticles directly into said cover or shell. These metal nanoparticles can be silver nanoparticles. In this embodiment, a portion of the back side of the cell phone case is not covered by heterogeneous and transparent Faraday-cage material, thereby permitting the electromagnetic waves to enter and exit the phone.

FIG. 4 illustrates another embodiment of the present invention as applied to a touch-screen phone design. The shell covering the non-display portions of the phone 13 may consist of, but is not limited to, plastic, rubber, or leather. The shell 13 shall be lined with the Faraday or conductive material. This material lining the shell shall consist of a cloth-like, plastic-like, paint, ink, or nearly any other type of Faraday or conductive material.

In this embodiment, the touch screen display portion of the phone 11 shall not be covered by the transparent Faraday or conductive material 18 while the user is actually utilizing the touch-screen feature. Instead, the transparent Faraday or conductive material has the capability of being removed or folding away from the screen, which enables the user to contact the screen directly for use. The foldable or removable portion has the capability to remain on the phone during this process, however. The transparent Faraday material may consist of, but is not limited to, an ITO material, carbon nanotube material, silver nanoparticle material, or a transparent conductive mesh material.

In the FIG. 4 embodiment, when the user is performing any other act besides operating the touch screen display portion of the phone 11 (e.g. talking on the phone), the transparent Faraday or conductive cover flap 18 can be folded back over the top of the touch screen display portion 11. While FIG. 4 depicts the cover flap folding down from the top edge of the phone, the present invention is not limited to utilizing the cover flap solely in this manner. Other embodiments may include folding the cover flap up from the bottom, over from either side, having a completely removable cover flap, or having a cover flap that slides over the top of the phone while remaining attached to the case. Additionally, the present invention shall be designed to comport with any jacks, cameras, ports, scroll balls, or any other comparable device contained on the phone 14.

In another embodiment, the entire cell phone case 11 and 13 is made out of a heterogeneous and transparent Faraday-cage material formed by doping Faraday metal nanoparticles directly into said cover or shell. These metal nanoparticles can be silver nanoparticles. In this embodiment, a portion of the back side of the cell phone case is not covered by heterogeneous and transparent Faraday-cage material, thereby permitting the electromagnetic waves to enter and exit the phone.

FIG. 5 illustrates the back portion of a phone enclosed in the present invention. FIG. 5 applies to a phone of any design, including but not limited to FIGS. 1-4. The shell covering lined with the Faraday or conductive material 13 covers a large portion of the surface area of the back of the phone. This material lining the shell shall consist of a cloth-like, plastic-like, paint, ink, or nearly any other type of Faraday or conductive material. However, an opening or non-Faraday material 16 is present on the back of the phone, which permits the signal to enter and exit the phone.

In another embodiment, the entire cell phone case 13 is made out of a heterogeneous and transparent Faraday-cage material formed by doping Faraday metal nanoparticles directly into said cover or shell. These metal nanoparticles can be silver nanoparticles. In this embodiment, a portion of the back side of the cell phone case is not covered by heterogeneous and transparent Faraday-cage material 16, thereby permitting the electromagnetic waves to enter and exit the phone.

FIG. 6 illustrates the flip phone design while the phone is in its folded-down state. The shell covering lined with the Faraday or conductive material 13 shall cover most of the surface area of the phone. However, the transparent Faraday or conductive material shall cover any display portions 17 that appear on the outside of the phone, which enables the user to see said display portions 17 while the cover is on the phone and the phone is in its folded-down, resting state.

In another embodiment, the entire cell phone case 13, 17 is made out of a heterogeneous and transparent Faraday-cage material formed by doping Faraday metal nanoparticles directly into said cover or shell. These metal nanoparticles can be silver nanoparticles. In this embodiment, a portion of the back side of the cell phone case is not covered by heterogeneous and transparent Faraday-cage material, thereby permitting the electromagnetic waves to enter and exit the phone.

### Prototypes

The inventors have produced at least three prototypes to date. One prototype was intended to illustrate the application of the present invention to a flip phone design. This prototype is similar to he embodiment shown in FIG. 1 above.

The next prototype was intended to illustrate one application of the present invention to a non-flip phone design where the keypad and display screen are contained on the front face of the phone. This prototype is compatible with a Blackberry. Further, this prototype is similar to the drawing shown in FIG. 2 above.

Another prototype was intended to illustrate one application of the present invention to a touch-screen design. This prototype is compatible with touch screen phones such as the iPhone. Further, this prototype is similar to the drawing shown in FIG. 4 above.

### Testing

The inventors submitted a prototype similar to the embodiment discussed in FIG. 2 for commercial testing. Specifically, the prototype was submitted to and tested by CETECOM on Feb. 17, 2010. CETECOM's model head was used for testing, with the cell phone apparatus being placed next to the head. For the test, the model head was filled with a liquid representing the electrical properties of the human brain. A probe was then used to measure the Specific Absorption Rate inside the head liquid caused by the cellular phone. The process was performed using only the cellular phone, and then a cellular phone encased by the embodiment of the present invention.

The purpose of the test was to measure how much radiation the present invention prevented from reaching the human tissue.

The test results showed that the embodiment of the present invention submitted for testing reduced the Specific Absorption Rate (i.e., the amount of radiation impinging upon human tissue) by 40%. Even more, the tests showed that the total radiated power decreased asymmetrically, meaning that the embodiment of the present invention submitted for testing redirected the signal away from the user.

Finally, the inventors performed their own tests to determine how much battery drain and signal loss was caused by encasing a cellular phone in embodiments of the present invention. These tests showed no significant battery drain or signal loss.

Although the description above contains many specificities, these should not be construed as limiting the scope of the embodiments but as merely providing illustrations of some of the presently preferred embodiments. The scope of the embodiments should be determined by the appended claims and their legal equivalents rather than by the examples given.

### Materials

The inventors have identified a company capable of making the transparent silver nanoparticle Faraday-cage material. This company is Sima Nanotech. Additionally, this company has the capability of adding additional metal, such as copper, to the silver nanoparticles to increase the ability of the material to block radiation.

Sima Nanotech also has the capability to provide the heterogeneous and transparent Faraday-cage material formed by doping Faraday silver nanoparticles directly into said cover or shell.

Utilizing these technologies to block cell phone radiation is a significant improvement over the prior art.

### REFERENCES

The following references as cited throughout this document are hereby incorporated by reference in their entirety herein.

U.S. Pat. No. 5,367,309

U.S. Pat. No. 5,335,366

U.S. Pat. No. 5,336,896

U.S. Pat. No. 5,657,386

U.S. Pat. No. 5,726,383

U.S. Pat. No. 6,001,282

U.S. Pat. No. 6,075,977

U.S. Pat. No. 6,095,820

U.S. Pat. No. 6,184,835

U.S. Pat. No. 6,341,217

U.S. Pat. No. 6,356,773

U.S. Pat. No. 6,359,213

U.S. Pat. No. 6,377,824

U.S. Pat. No. 6,404,403

U.S. Pat. No. 6,505,036

U.S. Pat. No. 6,515,223

U.S. Pat. No. 6,615,028

U.S. Pat. No. 6,624,432

U.S. Pat. No. 6,628,784

U.S. Pat. No. 6,603,981

U.S. Pat. No. 6,708,047

U.S. Pat. No. 6,738,650

U.S. Pat. No. 6,897,826

US 2001/0041545 A1

US 2002/0072337 A1

US 2002/0097188 A1

US 2002/0009976 A1

US 2003/0228843 A1

US 2003/0176164 A1

US 2004/0198264 A1

US 2004/0026100 A1

US 2008/0014872 A1

http://www.lessemf.com/cellphon.html

What is claimed is:

1. A cellular phone case comprising:
a front side designed to cover the front of the cellular phone;
a back side designed to cover the back of the cell phone;
an intermediate segment connecting said front side with said back side along the outer perimeters of said front side and said back side;
wherein the front side contains a transparent Faraday-cage material intended to cover the display screen of the cellular phone;
wherein the front side contains a transparent Faraday-cage material intended to cover the keypad of the phone;
wherein the back side contains a portion not covered by a Faraday-cage material, thereby permitting the electromagnetic waves to enter and exit the phone;
wherein the remaining surface area of said front portion, said back portion, and said intermediate portion are covered by any Faraday cage material, such as a metal paint or metal ink.

2. The cellular phone case of claim 1, wherein said transparent Faraday-cage material intended to cover the display screen of the cellular phone comprises a transparent material, such as plastic, coated with metal nanoparticles, such as silver nanoparticles.

3. The cellular phone case of claim 2, wherein additional metal, such as Copper, is added to the metal nanoparticles for additional radiation blockage.

4. The cellular phone case of claim 1, wherein said transparent Faraday-cage material intended to cover the keypad of the phone comprises a plastic coated with metal nanoparticles, such as silver nanoparticles, or a transparent Faraday cage fabric or cloth.

5. The cellular phone case of claim 1, wherein said front side, said back side, and said intermediate side contain a hole and/or a flap possessing Faraday-cage properties over any scroll ball or scroll key device contained on the phone, thereby permitting the user to operate the cellular phone while the case remains on the phone.

6. The cellular phone case of claim 1, wherein at least 40% of the radiation associated with cellular phone use is prevented from reaching the user's head.

7. The cellular phone case of claim 2, wherein said transparent Faraday-cage material intended to cover the keypad of the phone comprises a plastic coated with metal nanoparticles, such as silver nanoparticles, or a transparent Faraday cage fabric or cloth.

8. The cellular phone case of claim 7, wherein said front side, said back side, and said intermediate side contain a hole and/or a flap possessing Faraday-cage properties over any scroll ball or scroll key device contained on the phone, thereby permitting the user to operate the cellular phone while the case remains on the phone.

9. The cellular phone case of claim 8, wherein said intermediate segment connecting said front side with said back side has holes permitting the user to utilize cellular phone jacks while the case remains on the phone.

10. The cellular phone case of claim 9, wherein at least 40% of the radiation associated with cellular phone use is prevented from reaching the user's head.

11. The cellular phone case of claim 10, wherein said holes permitting the user to utilize cellular phone jacks are covered with flaps possessing Faraday cage properties.

12. The cellular phone case of claim 11, wherein additional metal, such as Copper, is added to the metal nanoparticles for additional radiation blockage.

13. A cellular phone case comprising:
a front side designed to cover the front of the cellular phone;
a back side designed to cover the back of the cell phone;
an intermediate segment connecting said front side with said back side along the outer perimeters of said front side and said back side;
wherein the front side contains a transparent Faraday-cage material intended to cover the display screen and/or keypad of the cellular phone;
wherein said transparent Faraday-cage material intended to cover the display screen and/or keypad of the cellular phone may be removed or folded away from covering said display screen and/or keypad of the cellular phone while remaining attached to the phone case.
wherein the back side contains a portion not covered by a Faraday-cage material, thereby permitting the electromagnetic waves to enter and exit the phone;
wherein the remaining surface area of said front portion, said back portion, and said intermediate portion are covered by any Faraday cage material, such as a metal paint or metal ink.

14. The cellular phone case of claim 13, wherein said transparent Faraday-cage material intended to cover the display screen and/or keypad of the cellular phone comprises a transparent material, such as plastic, coated with metal nanoparticles, such as silver nanoparticles.

15. The cellular phone case of claim 14, wherein additional metal, such as Copper, is added to the metal nanoparticles for additional radiation blockage.

16. The cellular phone case of claim 13, wherein said front side, said back side, and said intermediate side contain a hole and/or a flap possessing Faraday-cage properties over any scroll ball or scroll key device contained on the phone, thereby permitting the user to operate the cellular phone while the case remains on the phone.

17. The cellular phone case of claim 13, wherein at least 40% of the radiation associated with cellular phone use is prevented from reaching the user's head.

18. The cellular phone case of claim 14, wherein said front side, said back side, and said intermediate side contain a hole and/or a flap possessing Faraday-cage properties over any scroll ball or scroll key device contained on the phone, thereby permitting the user to operate the cellular phone while the case remains on the phone.

19. The cellular phone case of claim 18, wherein said intermediate segment connecting said front side with said back side has holes permitting the user to utilize cellular phone jacks while the case remains on the phone.

20. The cellular phone case of claim 19, wherein at least 40% of the radiation associated with cellular phone use is prevented from reaching the user's head.

21. The cellular phone case of claim 20, wherein said holes permitting the user to utilize cellular phone jacks are covered with flaps possessing Faraday cage properties.

22. The cellular phone case of claim 21, wherein additional metal, such as Copper, is added to the metal nanoparticles for additional radiation blockage.

23. A cellular phone case comprising:
a front cover designed to encase the front or top element of a cellular phone that flips or slides open for use;
a back cover designed to encase the back or bottom segment of a cellular phone that flips or slides open for use;
wherein the front cover and back cover contain transparent Faraday -cage materials intended to cover the display screens and keypad portions of the cellular phone;
wherein the back side of said back cover contains a portion not covered by a Faraday-cage material, thereby permitting the electromagnetic waves to enter and exit the phone;
wherein the remaining surface area of said front cover and said back cover are covered by any Faraday cage material, such as a metal paint or metal ink.

24. The cellular phone case of claim 23, wherein said transparent Faraday-cage material intended to cover the display screen of the cellular phone comprises a transparent material, such as plastic, coated with metal nanoparticles, such as silver nanoparticles.

25. The cellular phone case of claim 24, wherein additional metal, such as Copper, is added to the metal nanoparticles for additional radiation blockage.

26. The cellular phone case of claim 23, wherein said transparent Faraday-cage material intended to cover the keypad of the phone comprises a plastic coated with metal nanoparticles, such as silver nanoparticles, or a transparent Faraday cage fabric or cloth.

27. The cellular phone case of claim 23, wherein said front cover and said back cover contain a hole and/or a flap possessing Faraday-cage properties over any scroll ball or scroll key device contained on the phone, thereby permitting the user to operate the cellular phone while the case remains on the phone.

28. The cellular phone case of claim 23, wherein at least 40% of the radiation associated with cellular phone use is prevented from reaching the user's head.

29. The cellular phone case of claim 24, wherein said transparent Faraday-cage material intended to cover the keypad of the phone comprises a plastic coated with metal nanoparticles, such as silver nanoparticles, or a transparent Faraday cage fabric or cloth.

30. The cellular phone case of claim 29, wherein said front cover and back cover contain a hole and/or a flap possessing Faraday-cage properties over any scroll ball or scroll key device contained on the phone, thereby permitting the user to operate the cellular phone while the case remains on the phone.

31. The cellular phone case of claim 30, wherein said front cover and back cover contain holes permitting the user to utilize cellular phone jacks while the case remains on the phone.

32. The cellular phone case of claim 31, wherein at least 40% of the radiation associated with cellular phone use is prevented from reaching the user's head.

33. The cellular phone case of claim 32, wherein said holes permitting the user to utilize cellular phone jacks are covered with flaps possessing Faraday cage properties.

34. The cellular phone case of claim 33, wherein additional metal, such as Copper, is added to the metal nanoparticles for additional radiation blockage.

35. A cellular phone case comprising:
a cover or shell capable of encasing the cellular phone made of a heterogeneous and transparent Faraday-cage material formed by doping Faraday metal nanoparticles directly into said cover or shell;
wherein the back side of said cover or shell contains a portion not covered by said heterogeneous and transparent Faraday-cage material, thereby permitting the electromagnetic waves to enter and exit the phone;

36. The cellular phone case of claim 35, wherein said Faraday metal nanoparticles are silver nanoparticles.

37. The cellular phone case of claim 36, wherein additional metal, such as Copper, is added to the metal nanoparticles for additional radiation blockage.

38. The cellular phone case of claim 35,wherein the portion of the case intended to cover the display screen and/or keypad of the cellular phone may be removed or folded away from covering said display screen and/or keypad of the cellular phone while remaining attached to the phone case.

39. The cellular phone case of claim 35, wherein said cover or shell contains a hole and/or a flap possessing Faraday-cage properties over any scroll ball or scroll key device contained on the phone, thereby permitting the user to operate the cellular phone while the case remains on the phone.

40. The cellular phone case of claim 35, wherein at least 40% of the radiation associated with cellular phone use is prevented from reaching the user's head.

41. The cellular phone case of claim 36,wherein the portion of the case intended to cover the display screen and/or keypad of the cellular phone may be removed or folded away from covering said display screen and/or keypad of the cellular phone while remaining attached to the phone case.

42. The cellular phone case of claim 41, wherein said cover or shell contains a hole and/or a flap possessing Faraday-cage properties over any scroll ball or scroll key device contained on the phone, thereby permitting the user to operate the cellular phone while the case remains on the phone.

43. The cellular phone case of claim 42, wherein said intermediate segment connecting said front side with said back side has holes permitting the user to utilize cellular phone jacks while the case remains on the phone.

44. The cellular phone case of claim 43, wherein at least 40% of the radiation associated with cellular phone use is prevented from reaching the user's head.

45. The cellular phone case of claim 44, wherein said holes permitting the user to utilize cellular phone jacks are covered with flaps possessing Faraday cage properties.

46. The cellular phone case of claim 45, wherein additional metal, such as Copper, is added to the metal nanoparticles for additional radiation blockage.
